(19) United States
(12) Patent Application Publication
(10) Pub. No.: US 2026/0269776 A1
(43) Pub. Date: Sep. 10, 2026

(54) Frame For A Bi-Facial Solar Panel

(71) Applicant: Sun Terra Ltd., Nataf (IL)

(72) Inventors: Moshe Finarov, Rehovot (IL); Amir Lubinski, Modiin (IL); Zion Ovadia, Herzlia (IL)

(21) Appl. No.: 19/491,415

(22) PCT Filed: Jun. 5, 2024
(86) PCT No.: PCT/IL2024/050549

§ 371 Date: Dec. 9, 2025

(30) Foreign Application Priority Data
Jun. 12, 2023 (IL) 303637

(51) Int. Cl. H02S 30/10; H02S 20/30; H02S 40/22

(52) U.S. Cl. CPC H02S 30/10; H02S 20/30; H02S 40/22

(57) ABSTRACT

A frame for bi-facial solar panel assembly including several elongated metal members. The cross-section of the elongated metal members includes a beveled segment reducing the shading of the solar panel and increasing the solar panel power generation. The beveled segment of the frame facilitates the rainwater run off the panel. The location of frame mounting brackets is flexible and allows for easy repositioning of the brackets to meet the mounting requirements of the different mounting variations.

### TECHNOLOGY FIELD

The present disclosure relates to mounting photovoltaic panels, particularly the mounting of double-sided (bi-facial) photovoltaic panels with metal frames.

### BACKGROUND

Photovoltaic (PV) solar modules or panels generate electricity (electric power) when exposed to solar radiation or light. Solar panels are typically mounted in frames made from metal e. g. aluminum. The frame, also called a solar panel frame, is usually made of extruded aluminum profile. The frame fixes in place the solar panel, protects the panel edges from water and dust, facilitates solar panel transportation and mounting, and extends the panel's life.

Aluminum is widely used as a material for solar panels frames manufacture. Aluminum has light weight and other advantages over other materials. Aluminum solar panel frame usually comes with an anodized surface that increases corrosion resistance in the outdoor environment. The frame is lightweight, and it is easy to transport and install. The solar panel frame also provides mounting attachment points for the installation of different mounts like trackers, tilted stands, and others.

Recently, composite materials have become used for solar panel frame manufacture. Non-metal frames reduce the possibility of forming a current leakage circuit, helping to maintain the generated power. Composite materials frames have excellent corrosion resistance and can reduce production costs. The thermal expansion coefficient of composite material frames could be comparable to that of glass, which can avoid some thermal deformation of the frame and glass.

Typically a solar panel frame includes one side open to the sun's radiation or light. The back side of the solar panel frame is opaque. The open-to-the-sun radiation side includes silicon cells or silicon elements. Such solar panels are termed monofacial or single face panels. The surface of the exposed to sun silicon elements limits electricity by a single face panel production.

Recently, bi-facial solar panels have been introduced. The bi-facial solar panels expose to the sun both the front and back-side of the solar cells. Bi-facial solar panels produce electricity from both sides of the panel. The bi-faciality of the introduced panels was relatively low −60-70%). The contribution of sun radiation collected by the back side (mainly by diffused light) in a standard tilted to the South static horizontal mount of the bi-facial solar panel was a relatively small part of the total collected solar radiation (about 5-10%). Shading from the rear or back side of the bi-facial solar panel has not significantly affected the overall solar panel output. Bi-facial solar panels installed on a high albedo surface could increase electricity production.

Similar frames and technologies used to mount the mono-facial solar panels were transported to the bi-facial frames and panels mounting. United States Patents and patent publications U.S. Pat. No. 6,150,317 to Tomiuchi, U.S. Pat. No. 7,487,771 to Eiffen, U.S. Pat. No. 7,856,769 to Plaisted, U.S. 7,915,519 to Koboyashi, US Patent application publication 20040011354 to Earling, and US 20110155127 to Li., describe such frames. European patent EP 1995790 and Korean U.S. patent 102379412 also describe frames for solar panels.

### DEFINITIONS

As used in the present disclosure, “photovoltaic (PV) or solar panel” means a panel staffed with silicon elements that transform sunlight into direct current electrical energy.

As used in the present disclosure, “photovoltaic or solar module” means a photovoltaic (PV) or solar panel incorporated or mounted in a metal or composite material frame.

As used in the present disclosure, the term “bi-facial” defines the photovoltaic panel rear side efficiency ratio to the front side efficiency, measured under standard test conditions.

The present disclosure uses the term vertical plane, a virtual plane perpendicular to the ground.

As used in the present disclosure, a pivot is a rotation axis in the vertical plane, which is parallel to the ground, the tracking is a rotation of the PV panel plane around the pivot, and a tilt angle is an angle between the photovoltaic panel plane and the vertical plane.

Sealing is a process where an item, in the present case a photovoltaic (PV) solar panel, is sealed with a polymeric material to protect against a corrosive environment and mechanical damages.

### SUMMARY

The disclosure presents a bi-facial photovoltaic module for vertical mounting that includes a rectangular bi-facial photovoltaic panel and a metal frame covering all four edges of the photovoltaic panel. The metal frame consists of four elongated members and four corner elements connecting each pair of elongated members. The four elongated members have identical cross-sections.

The elongated members include, at one side, a recess receiving the edges of the photovoltaic panel and, at the opposite side, a slot for connecting the photovoltaic module by sliding T-nuts to an external mount or another photovoltaic module and a beveled segment. A cylindrical channel is made inside the elongated member to connect the elongated members to the corner elements.

The recess for receiving the edges of the photovoltaic panel in the elongated member includes a depression for excess glue and sealing material used for properly connection the bi-facial photovoltaic panel to the frame.

The PV module employs slidable T-nuts to attach intermediate connection brackets with mounting holes to the slots on respective sides of the frame and further connect the intermediate connection brackets to the tracker with the help of the mounting holes. The slidable T-nuts support locating the brackets in any location along the frame and facilitate matching the mounting holes to any external mount. Such type of frame and interfacing is especially useful for a vertically mounted PV system like the aerodynamic mount as disclosed in Israeli patent 292736 to the same assignee.

A vertically mounted photovoltaic system, such as for example, one disclosed in Israeli Patent 292736 includes a PV module mount. The mount includes two vertical posts anchored to the ground and configured to support at least one photovoltaic module on both sides of the photovoltaic module. A pair of hinges and a pivot coaxial with the hinges facilitate a free rotation of at least one photovoltaic module. The pivot is located above the center of mass of the PV module, and sliding T-nuts inserted into the slots of the frame attach the hinges to the frame of the PV module.

The frame for a bi-facial solar panel could be a metal frame or composite material frame assembled of four elongated members and four corner elements connecting each pair of elongated members. The cross-section of the elongated members includes at one side a recess receiving the edges of the photovoltaic panel and glass covers and at the opposite side a slot for connecting the metal frame by sliding T-nuts to an external mount or another photovoltaic module, and a beveled segment. A cylindrical channel is made inside the elongated member to connect the elongated members to the corner elements.

### LIST OF DRAWINGS AND THEIR SHORT DESCRIPTION

In order to understand the frame and method and to see how it may be carried out in practice, examples will now be described, by way of non-limiting examples only, with reference to the accompanying drawings, in which:

FIG. 1 is a schematically simplified illustration of a frame suitable for mounting of bi-facial solar panel;

FIG. 2A is an example of a corner element of the present solar module frame assembly;

FIG. 2B is a cross-section of the corner element of the present solar module frame assembly;

FIG. 3 is a cross-section A-A view of the solar panel frame's elongated extruded metal members;

FIG. 4A is a front view of the present bi-facial solar module assembly;

FIG. 4B is an example of a cross-section of the assembly of the present solar module;

FIG. 4C is an example of a cross-section of the assembly of the present solar module illustrating the operation of the beveled surfaces of the present solar module frame;

FIG. 5A is an illustration of the rear or back side of the current solar module frame assembly;

FIG. 5B is an example cross-section illustrating the assembly of the present solar module and showing a sliding T-nut;

FIG. 6 is a schematic illustration of a rack-mounted solar system, including a plurality of present solar modules; and

FIG. 7 provides details of the connection of the current solar module to an adjacent solar module or a system or rack of solar modules.

### DESCRIPTION

Developing and introducing vertically mounted solar modules, especially with a high bi-faciality and almost equal contribution of the front and back sides, have stimulated interest in bi-facial solar modules, particularly in vertically installed bi-facial solar systems.

The photovoltaic cells (PV cells) are connected within a solar panel in series, and even a small shading by the currently used standard frames of the back side of a bi-facial solar module decreases the overall generated power (10-20%), reducing the economic justification of such installation. Because of this, there is a growing interest in further improvement in gaining additional energy from the rear or back side of the solar panel. Recent market studies expect that by 2030 the bi-facial solar panels will grow to a market share of 60% to 70%.

United States Patent Publication 20220345073 to Hildebrant et al. discloses a photovoltaic system including a plurality of bi-facial PV modules mounted in a vertical arrangement. The shadowing of active surfaces of PV modules by the static cross-members and posts could be avoided by arranging the PV modules at a distance from each other in one configuration. Such PV module arrangement is effective for the sun radiation incidence angles of 20 degrees. In another configuration, the cross-members have a bevel on the lower side.

Therefore, large angles of incidence can also be ensured for border regions of the active surface of the PV module without shading by the respective cross-member To avoid shading of the back or rear side from the module's frame, practically, this configuration usually uses frameless PV modules.

The present disclosure provides a frame for a bi-facial PV module, which reduces the shading of the back side of the solar panel and supports gaining extra energy from the back side of the solar panel. The disclosed solar panel frame could be efficiently used for all types of installations, especially in vertical photovoltaic solar module mounts.

Bi-facial vertical solar panels are typically raised from the surface to facilitate solar radiation collection by both sides of the solar panel. The unobstructed airflow provides better cooling of the raised from the surface solar panel and reduces the probability of the solar panel overheating.

In most bi-facial photovoltaic module mounting configurations, the active surface on the rear side of the bifacial solar panels also collects the diffuse light, making the bi-facial solar panels more cost-effective than the monofacial solar panels.

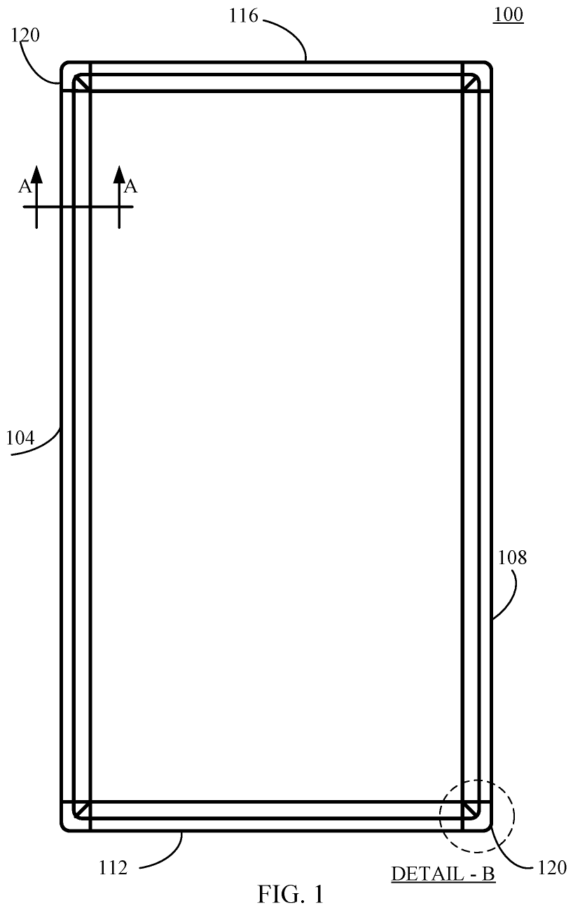

FIG. 1 is a front view of the present solar panel frame. Solar panel frame 100 includes a plurality of elongated metal, typically extruded aluminum frame members. Each frame member defines an inner and outer side of the solar panel frame 100. The first pair of elongated metal members made of extruded aluminum profiles 104 and 108 are arranged parallel to each other. A second pair of shorter elongated metal members 112 and 116 are also made of extruded aluminum profiles positioned parallel to each other and perpendicular to the first pair 104 and 108 of the elongated metal members. Although shown as having different lengths, in some examples, all the elongated metal members could be of equal length.

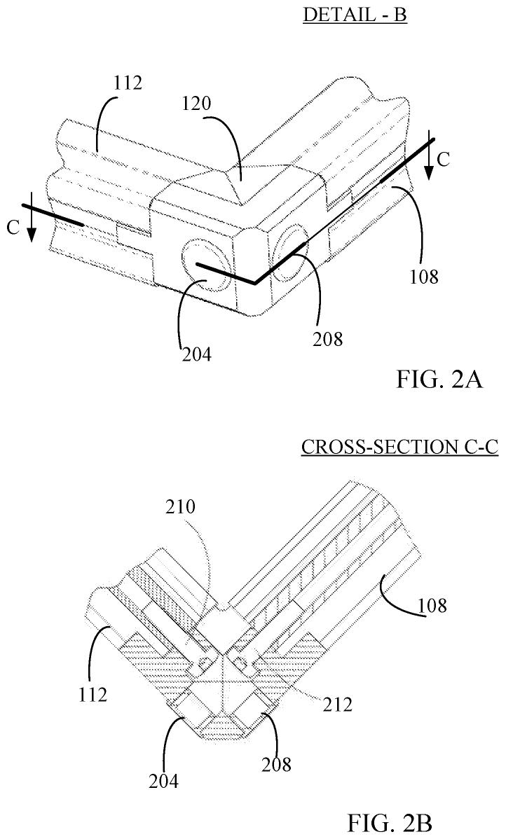

A plurality of corner elements 120 are configured to connect the pairs of a long 104 or 108, and the short 112 or 116 of elongated metal members to form a rectangle pattern. FIG. 2A is an example of a corner element of the current solar panel 100. This corner element may be made of aluminum, plastic, or any other material, which meets the requirements of stiffness and durability in outdoor conditions. The ends of the elongated metal members are adapted to receive the corner elements 120. A vertical and a horizontal (FIG. 2B) screw 210 and 212 inserted into cylindrical holes of the respective elongated members connect the corner elements 120 to the elongated members 108-122. Plugs 204 and 208 seal the cylindrical holes in the corner elements avoiding the corrosion of the screws.

The rectangle pattern of frame 100 receives the double glass bi-facial solar panel and forms a frame around the perimeter of the solar panel. Frame 100 also creates a frame around the periphery of the front and rear protective glasses.

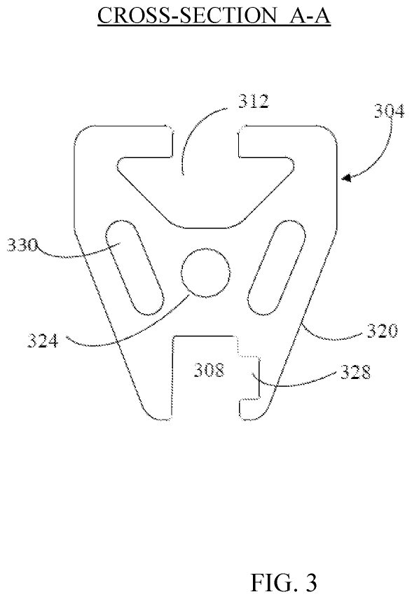

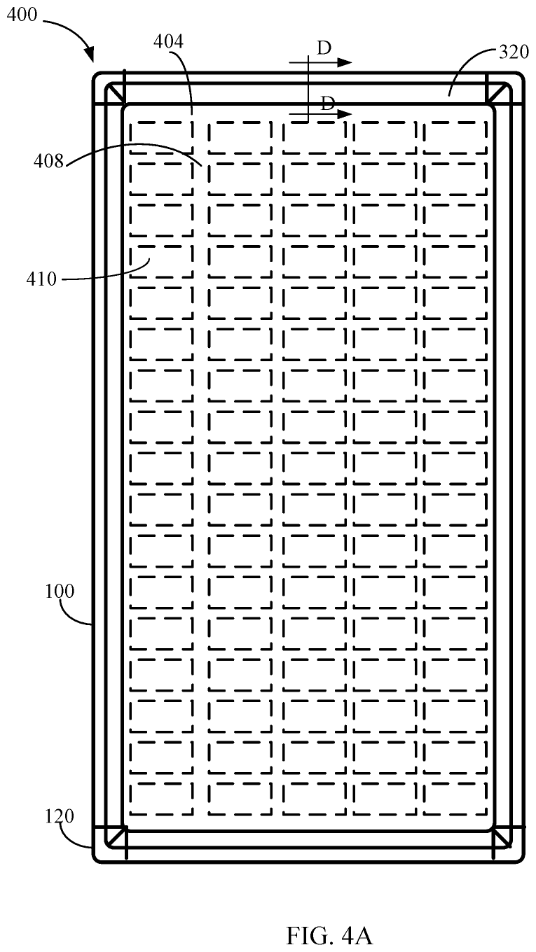

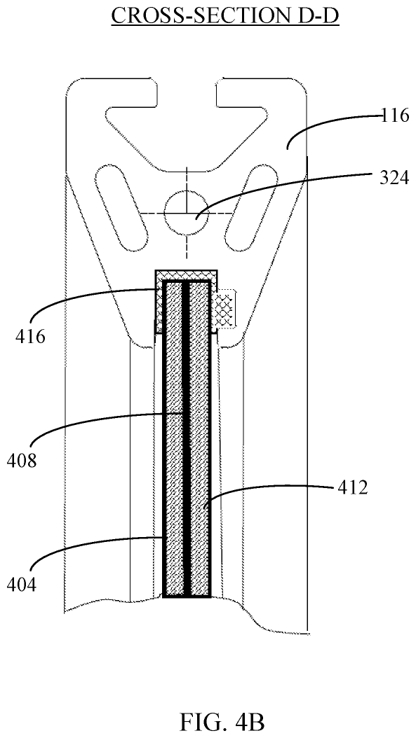

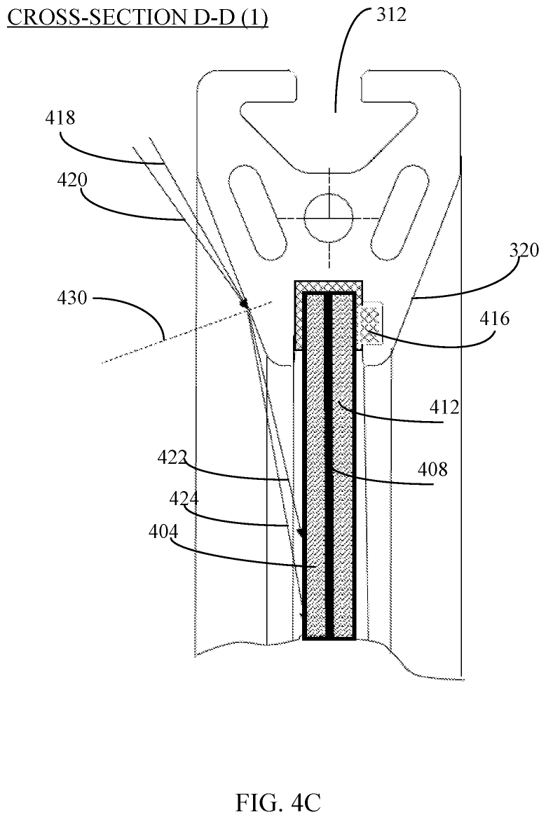

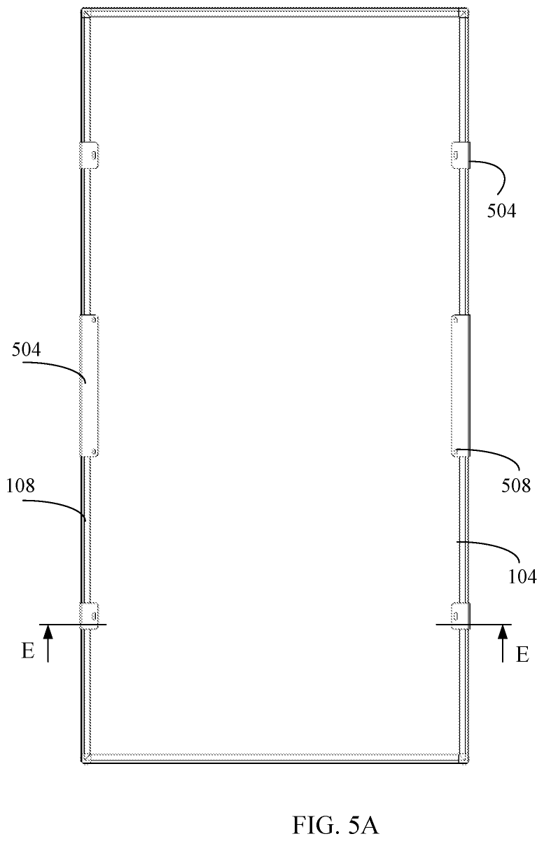

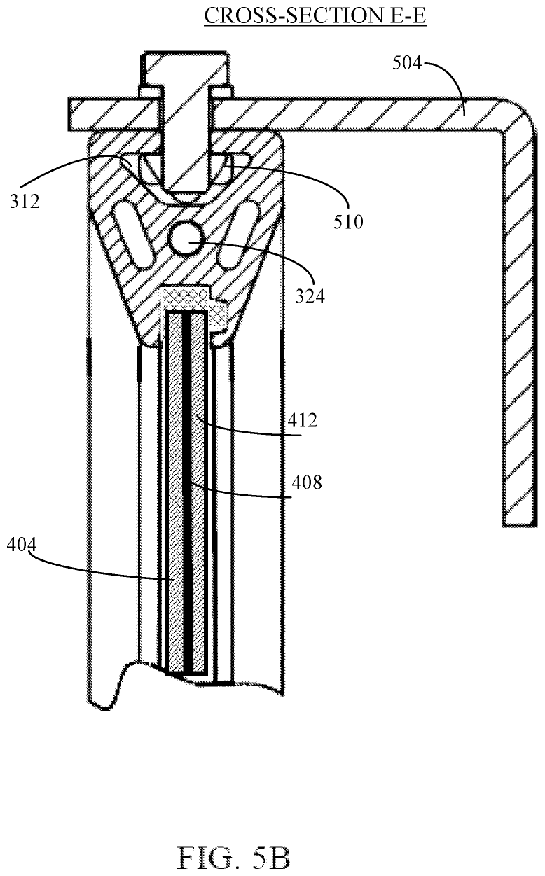

FIG. 3 is a cross-section A-A view of the solar panel frame's elongated extruded metal members. The elongated metal members 104, 108, 112, and 116 have identical cross-sections 304 or profiles. The cross-section of the elongated metal members profile includes at one side a recess 308 receiving the edges of the bi-facial photovoltaic panel and front and rear protective glass covers; a slot 312 for the opposite side of the metal member for connecting the metal frame 100 by sliding T-nuts 510 (FIG. 5B) to an external mount or another photovoltaic module, a beveled or tempered segment 320, and a cylindrical channel 324 made inside the elongated member for connecting the elongated metal members to corner elements 120. A vertical and a horizontal screw inserted into cylindrical holes of the respective elongated members connect the corner elements 120 to the elongated members. The beveled segment 320 reduces the shading of the solar panel rear side by frame 100 during almost all of the daytime and reflects solar radiation falling on the frame towards the active area (a matrix of silicon cells) of the solar panel. Cylindrical channel 324 extends the length of the elongated metal profile, supports the connection of the corner elements 120, and reduces the elongated metal member weight. Optionally, hollow channels 330 could be made to reduce the frame weight and cost further. Sliding T-nuts 510 (FIG. 5B) inserted in slot 312 could slide along the slot and support a flexible connection of the photovoltaic solar module to a solar tracker to a static rack or any other type of installation. Recess 308 could be filled with a sealing material 416 (FIG. 4B), e.g. a silicone sealant. A depression 328 is aimed at accepting an excessive volume of the sealing material. Sealing material 416 facilitates the proper mechanical connection of the solar panel edge to the frame and avoids penetration of water to the panel edges and the internal part of the frame, increasing the durability of the PV module.

FIG. 4A is a front view of the present bi-facial solar module assembly.

Frame 100, front cover glass 404, and silicon elements 410 are shown. Solar module 400 includes a bi-facial photovoltaic panel 408 located inside a metal frame assembly 100. Metal frame assembly 100 covers all four edges of the photovoltaic panel 408. As described above, the frame consists of four elongated members 108-116 (FIG. 1) and four corner elements 120 (FIG. 1) connecting each pair of elongated members. The four elongated members 108-116 have identical cross-sections. Vertical and horizontal screws 210 and 212 (FIG. 2B) inserted into cylindrical holes of both the corner elements 120 and the respective elongated members connect the corner elements 120 to the elongated members.

The elongated members include at one side (internal) a recess 308 (FIG. 3) receiving the edges of the photovoltaic panel, a slot at the opposite side (external) for connecting the photovoltaic module by sliding T-nuts 510 (FIG. 5B) assisting in the connection to an external mount or another photovoltaic module, and a beveled segment 320. A cylindrical channel 324 (FIG. 3) is made inside the elongated member 104-116. The cylindrical channel facilitates the connection of the elongated members 104-116 to the corner elements 120.

FIG. 4B is a cross-section E-E of a solar module 400. A depression 328 receives the excess of sealing material 416. The front cover glass 404 and the back cover glass 412 could be conventional glass covers similar to the ones for single-sided photovoltaic panels. In some examples, the front glass 404 and back cover glass 412 could be cover glasses with a surface texture enhancing solar light penetration to the photovoltaic cell matrix 408 for sun rays, which are close to being parallel to the panel surface, e.g. around noon time for vertically mounted PV modules. The surface texture is a plurality of prisms with a triangular base and height oriented along one of the glass cover sides-either in length or width. The angles of the base triangle could be different. For simplicity of description, presented here is an equilateral triangle; however, it may also be an isosceles triangle or a triangle with all different angles. PCT/IL2022/0500058 to the same assignee discloses such glass patterns.

Beveled segments 320 (FIG. 4C) could increase sunlight collection by both the front and back sides of bi-facial photovoltaic module 400. For example, sun rays 418, 420 falling on the beveled segment 320 of the frame elongated members are reflected (rays 422, 424 accordingly) towards the active area, a matrix of photovoltaic cells 408. Reference numeral 430 marks a perpendicular to beveled segment 320.

The use of a metal frame provides better sealing of the photovoltaic solar panel edges by using a sealant within a recess 308 in the frame. Depression 328 accepts the excess of the sealant when the panel is assembled with the frame. A metal frame could be equipped with mounting or connecting brackets 504 with holes 508 (FIG. 5) to easily mount the PV module on external mounts like trackers. A metal frame 100 ensures the safe transportation of PV modules, including in stacked packages.

FIG. 5A is an illustration of the rear or back side of the present solar panel frame assembly. Several mounting brackets 504 of different sizes and located along the long side 104 and 108 are attached to frame assembly 104. Each bracket 504 has one or more mounting holes 508 facilitating solar panel frame assembly 100 connection to a tracking mechanism or another solar panel support stand or rack. The location of mounting brackets 504 along the long sides 104 and 108 is flexible and allows for easy repositioning of brackets 404 along the long sides 104 and 108. Mounting brackets 504 repositioning allows meeting mounting system variations (e.g. vertical or horizontal mount) and easy matching between frames, solar modules, and mounts. Solar panel mounts can be customized to facilitate the effective positioning of the attached solar panel or array to meet these parameters.

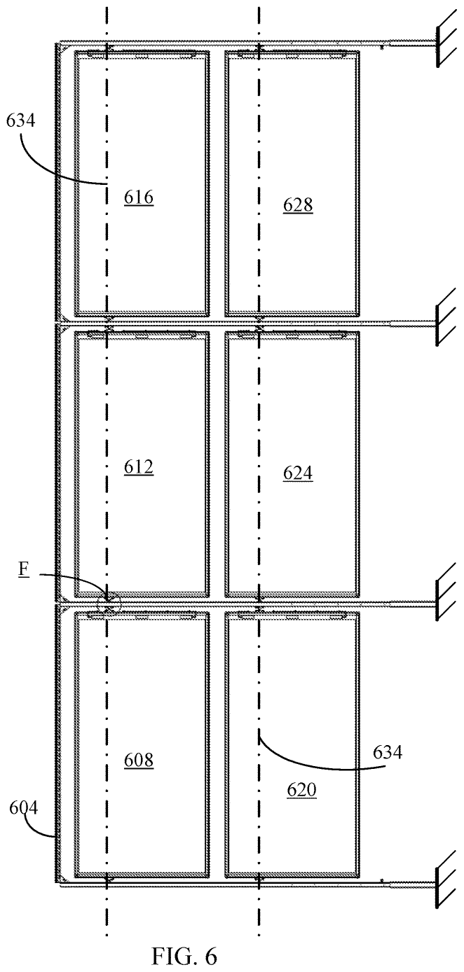

FIG. 5B is an example cross-section illustrating the assembly of the present solar module showing a sliding T-nut. A mounting bracket 504 with the help of sliding T-nut 510 inserted into slot 312 of the frame member 104, connects the photoelectric module 400 (FIG. 4) to a photoelectric system rack e.g. 604 (See FIG. 6).

The purpose of a solar module mounting system is to position the solar module at the right angle and location so that the solar panel exposure will be maximal to the maximum amount of sunlight. FIG. 6 is a schematic illustration of a rack-mounted solar system, including a plurality of the present bi-facial solar-modules. The solar modules could be of any type, including the bi-facial solar modules disclosed in Israeli patent 292736 to the same assignee.

Although only six modules, 608 through 628, are illustrated, rack 604 is configured to support mounting a single panel and a plurality of the present solar modules.

Interconnecting assembly D serves as a bi-facial solar module rotation or tilting axis for each of the solar modules 608 through 628. Reference numeral 634 marks the rotation axis of the solar modules. As disclosed in Israeli patent 292736 to the same assignee (PCT/IL2023/050050), locating the pivot or hinge above the center of mass of the PV module facilitates free rotation of the PV module. The wind directed towards the PV module plane lifts or tilts the PV module and rotates it around the pivot. Therefore, the wind load acts against the PV module weight: the higher the wind speed, the greater the tilt angle of the PV module plane relative to the vertical plane. The PV module will be positioned close to the horizontal plane in the extreme case of very high wind speed. Therefore, the drag force on the posts holding the PV module with the help of hinges or bearings is always reduced. Since the pivot is located above the center of mass of the PV module after the wind drops, the gravitation force returns the PV module to the original vertical position. The wind power places each of the solar panels at an angle that minimizes the wind load on the rack 604.

The described solar panel frame ensures minimal solar panel shading in all types of installations, especially in bi-facial vertically mounted solar panels. The beveled or tempered frame segments 320 support reflection of additional light from the frame's slopes towards the active PV panel area collection. This increases the light collection of both sides of the solar module at most of the daytime.

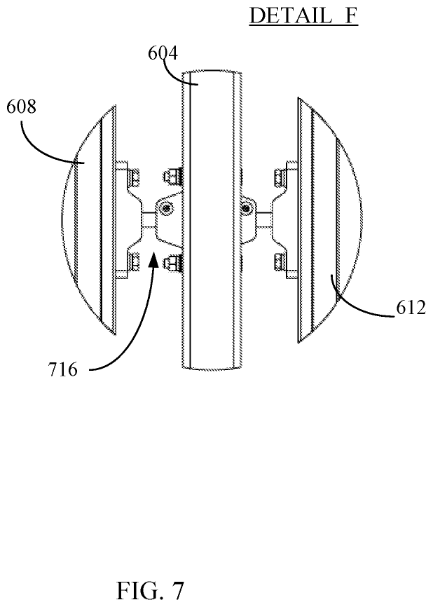

FIG. 7 is an example of a connection of the bi-facial solar module to a vertical mount or rack of solar modules. Israeli patent 292736 to the same assignee discloses this type of connection. Such type of connection could be used, for example, in a solar fence, along highways or railways. In the figure, reference numeral 604 marks a rack, post, or pole to which the first solar module 608 and the second solar module 612 (FIG. 6) are mounted. Reference numeral 716 marks the interconnection assembly. When the installed solar panel is a construction disclosed in Israeli patent 292736 to the same assignee, the interconnection assembly could serve as an axis of rotation or tilting of each of the solar modules.

The described solar panel frame generates minimal solar panel shading in all types of installations, especially in vertically mounted solar panels. The slopes or tempers of the beveled segments support the collection of light reflected from the bevels by a matrix of photovoltaic cells.

The long and short elongated frame segments 108-116 have identical cross-section (profile). The elongated frame segments are manufactured by a standard aluminum extrusion method.

The frame assembly is simple and does not require a qualified workforce. The solar panel frame is easy and stiff. The frame assembly is performed by joining the long and short elongated members by corner holders or elements with screws entering the cylindrical channels. The holders could be manufactured e.g. from a low-cost plastic material.

The same glass and solar panel mounting and sealing within the recesses technique is used as in the standard single-facial frames. Flexible connection to any external mount with the help of slidable T-nuts inserted in the mounting slots supports an easy change of the rotating axis location in the aerodynamic solar panel mount. (See PCT/IL2022/0500058 to the same assignee)

The flexible location of the solar module mounting holes provides easy matching between solar modules and mounts.

Manufacturing by a standard aluminum extrusion process allows for low cost for elongated frame segments.

Reducing the shading of the back-side of bi-facial solar panels reduces the electrical mismatch loss within the silicon cell matrix of the photovoltaic panel. The rounded corners of the frame prevent frost build-up in the winter.

It will be appreciated by persons skilled in the art that the present disclosure is not limited to what has been particularly shown and described hereinabove. Rather, the scope of the method and apparatus includes combinations and sub-combinations of various features described hereinabove as well as modifications and variations thereof which would occur to a person skilled in the art upon reading the preceding description which is not in the prior art.

We claim:

1. A bi-facial photovoltaic module comprising:
a rectangular bi-facial photovoltaic panel;
a metal frame covering all four edges of the photovoltaic panel and
wherein the frame consists of four elongated members and four corner elements connecting each pair of the elongated members, and wherein the four elongated members have identical cross-sections; and
wherein the elongated members include at one side a recess receiving the edges of the photovoltaic panel, a slot at the opposite side for connecting the photovoltaic module by sliding T-nuts to an external mount or another photovoltaic module, and a beveled segment, and a cylindrical channel made inside the elongated member for connecting the elongated members to the corner elements.

2. The bi-facial photovoltaic module, according to claim 1, wherein one vertical and one horizontal screw inserted into cylindrical holes of the respective corner elements and elongated members connect the corner elements to the elongated members.

3. The bi-facial photovoltaic module, according to claim 1, wherein the recess for receiving the edges of the bi-facial photovoltaic panel in the elongated member includes a depression for excess of a sealing material used for connection the bi-facial photovoltaic panel to the frame.

4. The bi-facial photovoltaic module, according to claim 1, wherein the beveled segment of the elongated metal member reduces the shading of the bi-facial solar panel and increases the power generation of the bi-facial solar panel by reflecting the incident on the beveled segments light towards the active area of the solar panel.

5. The bi-facial photovoltaic module, according to claim 1, wherein the metal frame for the bi-facial solar module includes mounting brackets connected to the frame slots by sliding T-nuts to allow flexible connection of the photovoltaic module to different types of allowing meeting variations of the mounting system.

6. The bi-facial photovoltaic module, according to claim 1, wherein the rotation (tilting) axis of the bi-facial module is above the center of mass of the bi-facial photovoltaic module.

7. The bi-facial photovoltaic module, according to claim 1, wherein a sliding T-nut inserted in an elongated metal profile slot slides along the slot and supports the connection of the bi-facial photovoltaic module frame assembly to a solar tracker or a static rack installation.

8. A vertically mounted photovoltaic system comprising:
at least one PV module of claim 1 and a PV module mount, including two vertical posts anchored to the ground and configured to support at least one photovoltaic module at both sides of the photovoltaic module; and
a pair of hinges and a pivot coaxial with the hinges, and facilitating a free rotation of the at least one photovoltaic module; and
wherein the pivot is located above the center of mass of the at least one PV module; and
wherein sliding T-nuts inserted into the slots of the frame attach the hinges to the frame of the at least one PV module.

9. A frame for a bi-facial solar panel comprising:
a metal frame assembled of four elongated members and four corner elements connecting each pair of elongated members, and wherein the four elongated members have identical cross-sections; and
wherein the elongated members include at one side a recess receiving the edges of the photovoltaic panel, a slot for connecting the metal frame by sliding T-nuts to an external mount or another photovoltaic module, a beveled segment, and a cylindrical channel made inside the elongated member for connecting the elongated members to the corner elements.

10. The frame, according to claim 9, wherein reducing the shading of the bi-facial solar panel increases the power generation efficiency of the bi-facial solar panel.

11. The frame, according to claim 9, wherein the frame and the elongated metal members (108-116) for the bi-facial solar panel include rounded corners that prevent winter frost build-up.

12. The frame, according to claim 9, wherein the frame for the bi-facial solar panel includes repositionable mounting brackets allowing meeting variations of the mounting system.

13. A method of increasing a bi-facial solar module generated electric power comprising:
providing at least one bi-facial solar panel embedded in a frame including elongated frame members with a cross-section including a beveled segment (208), the beveled segment reduces the shading of the photovoltaic panel and adds light collection by reflecting the light falling onto the frame towards the photovoltaic panel.

14. A method for mounting a bi-facial solar panel comprising:
providing at least one bi-facial solar panel mounted on a rack, the bi-facial solar panel embedded in a frame from elongated frame members with a cross-section including a beveled segment (tempered) (208);
the method characterized by that
the location of mounting brackets along the long sides of the frame is flexible and allows for easy repositioning of the mounting bracket for meeting mounting system variations and easy matching between frames, solar modules, and mounts.
